(19) United States
(12) Patent Application Publication
(10) Pub. No.: US 2006/0068740 A1
(43) Pub. Date: Mar. 30, 2006

(54) Receiver if circuit including image rejection mixer and active bandpass filter

(75) Inventor: Akio Yokoyama, Ibaraki-shi (JP)

Correspondence Address: HAMRE, SCHUMANN, MUELLER & LARSON P.C., P.O. BOX 2902-0902, MINNEAPOLIS, MN, 55402, US

(73) Assignee: MATSUSHITA ELECTRIC INDUSTRIAL CO., LTD., Kadoma-shi (JP)

(21) Appl. No.: 11/230,744

(22) Filed: Sep. 20, 2005

(30) Foreign Application Priority Data
Sep. 24, 2004 (JP) 2004-276864

(51) Int. Cl. H04B 7/00

(52) U.S. Cl. 455/302; 455/234.1

(57) ABSTRACT

A receiver IF circuit includes the following: a variable gain amplifier for amplifying an RF input signal; a frequency converter for mixing the amplified RF input signal and a local signal to generate polyphase intermediate-frequency signals that are used for suppressing an image component; a polyphase filter for receiving the polyphase intermediate-frequency signals and outputting an intermediate-frequency signal whose image component is suppressed; a frequency variable band-pass filter for selecting a channel of the intermediate-frequency signal while changing a frequency response in accordance with a supplied control signal; an IF demodulator for demodulating the intermediate-frequency signal; and an automatic gain control for detecting a level of an output signal of the IF demodulator and controlling a gain of the variable gain amplifier in accordance with the detected level. Using the polyphase filter and the frequency variable band-pass filter, the receiver IF circuit can achieve high-performance integration of an image rejection filter and a channel selection filter.

### BACKGROUND OF THE INVENTION

1. Field of the Invention

The present invention relates to a receiver IF (intermediate frequency) circuit, particularly a receiver IF circuit in which a filter constituting an image rejection mixer is integrated with a filter having a channel selection function.

2. Description of Related Art

FIG. 7 shows a conventional superheterodyne radio receiver. When an RF signal is input, an RF filter 1 rejects an undesired signal including an image signal and transmits a desired signal. The RF signal that has passed through the RF filter 1 is amplified by a variable gain amplifier 2 and mixed with a local-frequency signal of an oscillator 4 by a frequency mixer 3, so that the frequency is converted into an intermediate frequency (IF). Then, a band-pass filter (BPF) 6b removes an undesired signal from the output signal of the frequency mixer 3 and transmits only a desired IF signal. The band-pass filter 6b is composed mainly of an external passive component such as a ceramic filter. The output signal of the band-pass filter 6b is amplified by an IF amplifier 7 and subsequently is converted into a baseband signal by an IF demodulator 8.

The amplitude of the signal after demodulation is detected by an AGC (automatic gain control) 9. The output of the AGC 9 is supplied to the variable gain amplifier 2 and the IF amplifier 7 as a gain control voltage for maintaining the amplitude of the baseband signal constant. The gains of the variable gain amplifier 2 and the IF amplifier 7 are controlled based on the gain control voltage so that an appropriate dynamic range is kept for the amplifiers and the filters. The region enclosed with a broken line represents an integrated block 10. The indication is the same for the following description. The RF filter 1 and the band-pass filter 6b are located outside the integrated block 10.

Next, image interference that is a problem of the heterodyne system will be described. FIG. 8 is a conceptual diagram of the image interference. FIG. 8(a) shows a frequency conversion by the mixer 3. This figure shows a down-converting operation performed when the RF signal entering the mixer 3 through the RF filter 1 includes a desired wave V_{RF} and an image wave V_{IM}. As shown in FIG. 8(b), the desired wave V_{RF} has a frequency (f_{LO}+f_{IF}) that is higher than a local signal frequency f_{LO} by the amount equal to an intermediate frequency f_{IF}. The image wave V_{IM} has a frequency (f_{LO}−f_{IF}) that is lower than the local signal frequency f_{LO} by the amount equal to the intermediate frequency f_{IF}.

As shown in FIG. 8(c), whether the desired wave V_{RF} having a frequency (f_{LO}+f_{IF}) or the image wave V_{IM} having a frequency (f_{LO}−f_{IF}) is input to the receiver system, it is down-converted by the mixer 3 and transmitted by the band-pass filter 6b to generate a signal V_{OUT} with the same intermediate frequency f_{IF}. Therefore, interference occurs due to the image signal and may degrade the reception quality. Accordingly, the RF filter 1 generally is used to reject the image wave beforehand.

However, the external RF filter 1 increases the cost and makes it difficult to reduce the packaging density per substrate. In recent years, therefore, an image rejection mixer has been employed to deal with the image interference (e.g., JP 2001-513275, JP 2003-298356, or Sharzad Tadjpour and three others, “A 900-MHz Dual-Conversion Low-IF GSM Receiver in 0.35-μm CMOS” ISSCC, Vol. 36, No. 12, December, 2001). The image rejection mixer rejects the image wave with a circuit technology. Using this image rejection mixer can eliminate the function of rejecting the image wave from the external RF filter 1. FIG. 9 shows an example of the image rejection mixer.

In FIG. 9, a desired wave A_{RF}cosω_{RF}t and an image wave A_{IM}cosω_{IM}t are input (RF input). As local signals, sinω_{LO}t is supplied to a mixer 3a and cosω_{LO}t is supplied to a mixer 3b. The high-frequency component included in the output signal of the mixer 3a is rejected by a LPF (low-pass filter) 50a. Thus, the output signal of the LPF 50a is expressed by Formula (1). The signal that has passed through a 90-degree phase shifter 51 is expressed by Formula (2).
(A_{RF}/2)·sin(ω_{LO}−ω_{RF})t+(A_{IM}/2)·sin(ω_{LO}−ω_{IM})t Formula (1)
(A_{RF}/2)·cos(ω_{RF}−ω_{LO})t−(A_{IM}/2)·cos(ω_{LO}−ω_{IM})t Formula (2)
On the other hand, the signal that has been output from the mixer 3b and passed through a LPF 50b is expressed by Formula (3).
(A_{RF}/2)·cos(ω_{RF}−ω_{LO})T+(A_{IM}/2)·cos(ω_{LO}−ω_{IM})t Formula (3)
Consequently, the output of an adder 52 is A_{RF}cos(ω_{RF}−ω_{LO})t, and the image signal A_{IM}cos(ω_{LO}−ω_{IM})t can be removed.

As the 90-degree phase shifter 51, a CR/RC circuit that utilizes a 90-degree difference in phase between the voltage at both ends of a capacitor and the voltage at both ends of a resistor may be used. However, the image rejection characteristics are degraded because of a narrow bandwidth of the 90-degree phase sifter 51, property variations of the capacitor and the resistor, and amplitude or phase errors of two signals with a 90-degree phase difference. Therefore, a polyphase filter has been used instead of the 90-degree phase shifter 51 (e.g., the above-mentioned JP 2003-298356 or Sharzad Tadjpour and three others, “A 900-MHz Dual-Conversion Low-IF GSM Receiver in 0.35-μm CMOS” ISSCC, Vol. 36, No. 12, December, 2001).

FIG. 10 shows an example of the configuration of a passive polyphase filter. In the passive polyphase filter of FIG. 10, polyphase filters 53-1, 53-2, . . . and 53-n, each of which has four phases, are connected in n stages. The polyphase filter 53-1 includes resistors R11 to R14 and capacitors C11 to C14. The polyphase filter 53-2 includes resistors R21 to R24 and capacitors C21 to C24. The polyphase filter 53-n includes resistors Rn1 to Rn4 and capacitors Cn1 to Cn4.

FIG. 11 shows the image rejection characteristics of the passive polyphase filter of FIG. 10. In FIG. 11, a broken line 54 represents the characteristics when a desired signal is input, and a solid line 55 represents the characteristics when an image signal is input. A difference between the characteristics of the broken line 54 and the solid line 55 is image rejection. Since the polyphase filters are connected in multiple stages, the bandwidth becomes broader. Therefore, even if the elements vary, the image rejection characteristics are degraded less.

FIG. 12 shows an example of an active polyphase filter for image rejection. In FIG. 12, input signals I, −I, Q and −Q have the same amplitude, but different phases of 0, −180, 90 and −90 degrees, respectively. Reference numerals 30-1, 30-2, . . . and 30-n are BPFs and connected in n stages. The BPF 30-1 includes operational amplifiers 31-1 and 32-1, resistors R1a, R1b and R1c, and capacitor C1a. The BPF 30-2 includes operational amplifiers 31-2 and 32-2, resistors R2a, R2b and R2c, and capacitor C2a. The BPF 30-n includes operational amplifiers 31-n and 32-n, resistors Rna, Rnb and Rnc, and capacitor Cna.

By using the polyphase filter, it is possible to reduce the degradation of the image rejection characteristics due to a variation in property of each element. FIG. 13 shows an example of the image rejection characteristics of the active polyphase filter. In FIG. 13, a broken line 56 represents the frequency characteristics when a desired signal is input, and a solid line 57 represents the frequency characteristics when an image signal is input. A difference between the frequency characteristics of the broken line 56 and the solid line 57 is image rejection. The active polyphase filter is a band-pass filter and rejects signals outside of a certain band. Thus, the active polyphase filter also can be used as part of a channel filter.

In order to reduce the cost, there has been an attempt to replace the passive components with the active components (e.g., the above-mentioned JP 2001-513275). FIG. 14 shows an example of a receiver in which the band-pass filter 6b (passive band-pass filter) in FIG. 7 is replaced with a band-pass filter 6a composed of a switched capacitor filter (SCF). The basic operation is the same as that in FIG. 7. In FIG. 14, reference numeral 58 is an anti-aliasing filter for preventing aliasing caused by using the SCF. The band-pass filter 6a removes an undesired signal from the signal that has passed through the anti-aliasing filter 58 after mixing and transmits only a desired intermediate-frequency signal. A frequency divider 11 divides the output signal of the oscillator 4 to generate a signal with a desired frequency, and supplies it as a clock for the SCF of the band-pass filter 6a. A smoothing filter 42 removes a clock signal and its harmonic from the output of the band-pass filter 6a.

In the radio receiver, the input signal bands are broad, and signals with different modulation types such as AM or FM are input. Therefore, the radio receiver requires not only a channel filter that amplifies only a desired signal in various frequency bands, but also an image rejection filter for the heterodyne system. Thus, many receiving channel filters should be used, which increases the number of passive filters and makes it difficult to reduce the cost and the packaging area. Although the passive components may be replaced with the active components as disclosed in JP 2001-513275, many active filters are needed for each of the input signal bands or the types of signals. This may lead to an increase in circuit current, chip area, or noise.

In the conventional examples of FIGS. 7 and 14, the RF filter 1 has both functions of the image rejection filter and the channel filter, and the band-pass filters 6a, 6b have the functions of rejecting an undesired signal after mixing and selecting only a desired IF signal. For the circuit in FIG. 7, these filters are composed mainly of a ceramic filter, SAW filter, or the like and should have enhanced selecting characteristics and image rejecting function. Therefore, when the filters are integrated into an active circuit, they must ensure higher precision, and are not likely to be stable against variations in element property. For the circuit in FIG. 14, which uses a switched capacitor filter (active filter) as the band-pass filter 6a, the anti-aliasing filter 58 has to be provided in the preceding stage of the band-pass filter 6a, although tuning is not necessary because the filter characteristics of the switched capacitor filter are synchronized with a clock. In order to achieve high-precision filters, the anti-aliasing filter also should have high precision and a large size. Thus, the chip cost, power consumption, or noise is increased to make integration difficult.

FIG. 15 shows an example of a receiver system that receives two RF input signals in different signal bands. In this system, an RF1 signal enters an RF1 amplifier 2a through an RF1 filter 1a, and an RF2 signal enters an RF2 variable gain amplifier 33 through an RF2 filter 1b.

The RF1 signal is subjected to double down-conversion. The output of a mixer 3 passes through an IF1 band-pass filter 60, and subsequently is mixed with a second local signal by a second mixer 61 and converted into IF12. The IF12 is processed by an IF12 band-pass filter 62, an IF12 amplifier 63, and an IF12 demodulator 64, so that a baseband signal 1 is output.

The output of the RF2 variable gain amplifier 33 is processed in the same manner as the circuit in FIG. 7 by a mixer 3c, an IF2 band-pass filter 65, an IF2 amplifier 66, an IF2 demodulator 67, and an AGC 68, so that a baseband signal 2 is output.

The RF filters 1a and 1b, the IF1 band-pass filter 60, and the IF2 band-pass filter 65 are needed for each of the RF1 and RF2 signals. These filters have to be used depending on the functions and frequency characteristics of the image rejection filter or the channel selection filter.

### SUMMARY OF THE INVENTION

Therefore, with the foregoing in mind, it is an object of the present invention to provide a receiver IF circuit that can achieve high-performance integration of an image rejection filter and a channel selection filter at low cost, and thus can reduce the cost of a receiver and the area of a substrate for reception.

A receiver IF circuit of the present invention includes the following: a variable gain amplifier for amplifying an RF input signal; a frequency converter for mixing the amplified RF input signal and a local signal to generate polyphase intermediate-frequency signals that are used for suppressing an image component; a polyphase filter for receiving the polyphase intermediate-frequency signals and outputting an intermediate-frequency signal whose image component is suppressed; a frequency variable band-pass filter for selecting a channel of the intermediate-frequency signal while changing a frequency response in accordance with a supplied control signal; an IF demodulator for demodulating the intermediate-frequency signal; and an automatic gain control for detecting a level of an output signal of the IF demodulator and controlling a gain of the variable gain amplifier in accordance with the detected level.

### BRIEF DESCRIPTION OF THE DRAWINGS

FIG. 1 is a block diagram showing a receiver IF circuit of Embodiment 1 of the present invention.

FIG. 2 shows an example of a SCF used as an active filter of a frequency variable band-pass filter.

FIG. 3 is a block diagram showing a receiver IF circuit of Embodiment 2 of the present invention.

FIG. 4 is a block diagram showing a receiver IF circuit of Embodiment 3 of the present invention.

FIG. 5 shows a specific example of a multistage biquadratic active LPF.

FIG. 6 is a block diagram showing a receiver IF circuit of Embodiment 4 of the present invention.

FIG. 7 is a block diagram showing a conventional receiver IF circuit.

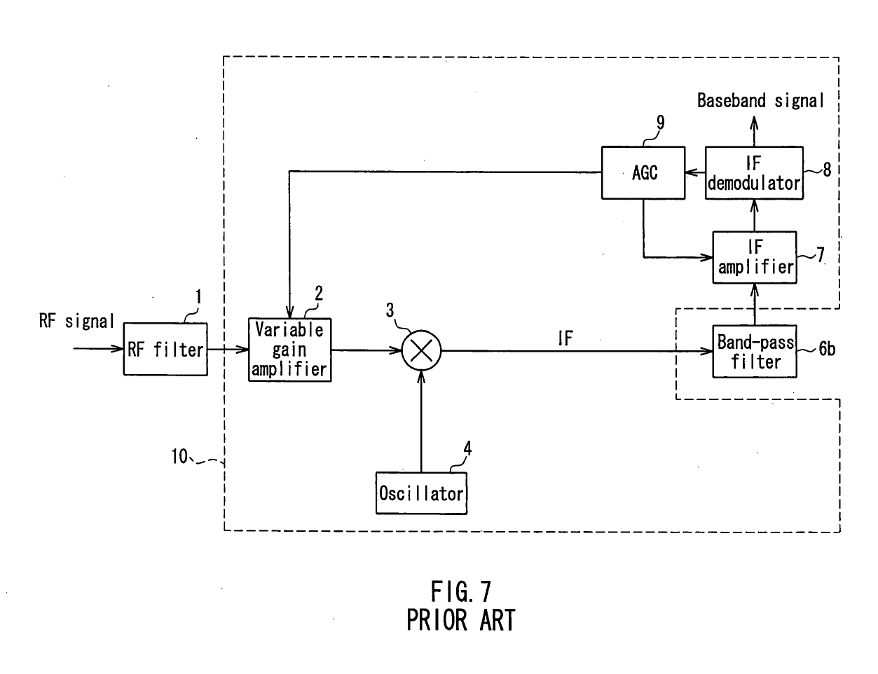

FIG. 8 is a diagram for explaining interference caused by an image signal.

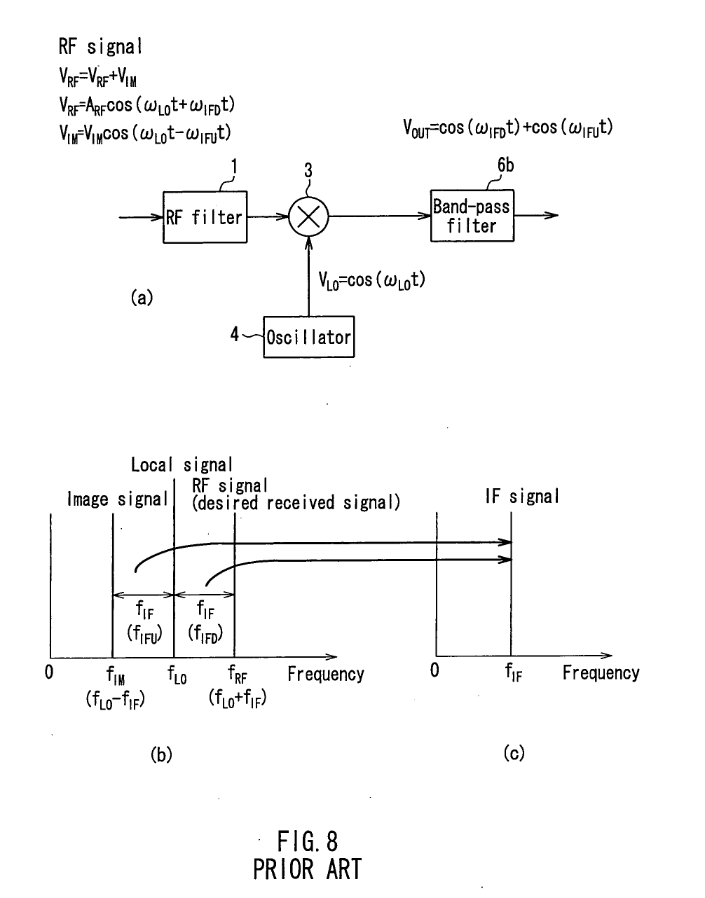

FIG. 9 is a block diagram schematically showing a conventional image rejection mixer.

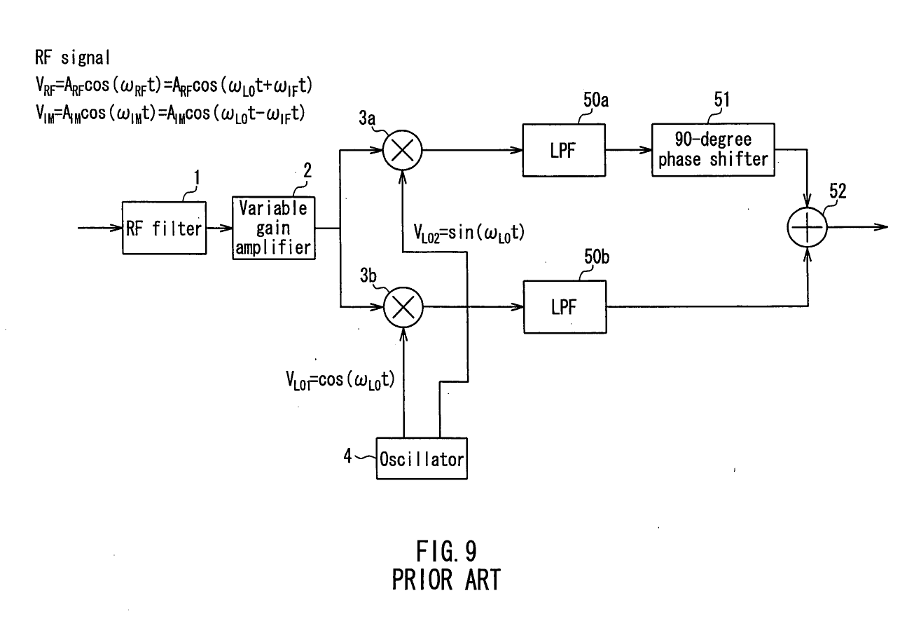

FIG. 10 is a circuit diagram showing an example of a passive polyphase filter.

FIG. 11 shows the image rejection characteristics of the passive polyphase filter.

FIG. 12 is a circuit diagram showing an example of an active polyphase filter.

FIG. 13 shows the image rejection characteristics of the active polyphase filter.

FIG. 14 is a block diagram showing another example of a conventional receiver IF circuit.

FIG. 15 is a block diagram showing yet another example of a conventional receiver IF circuit.

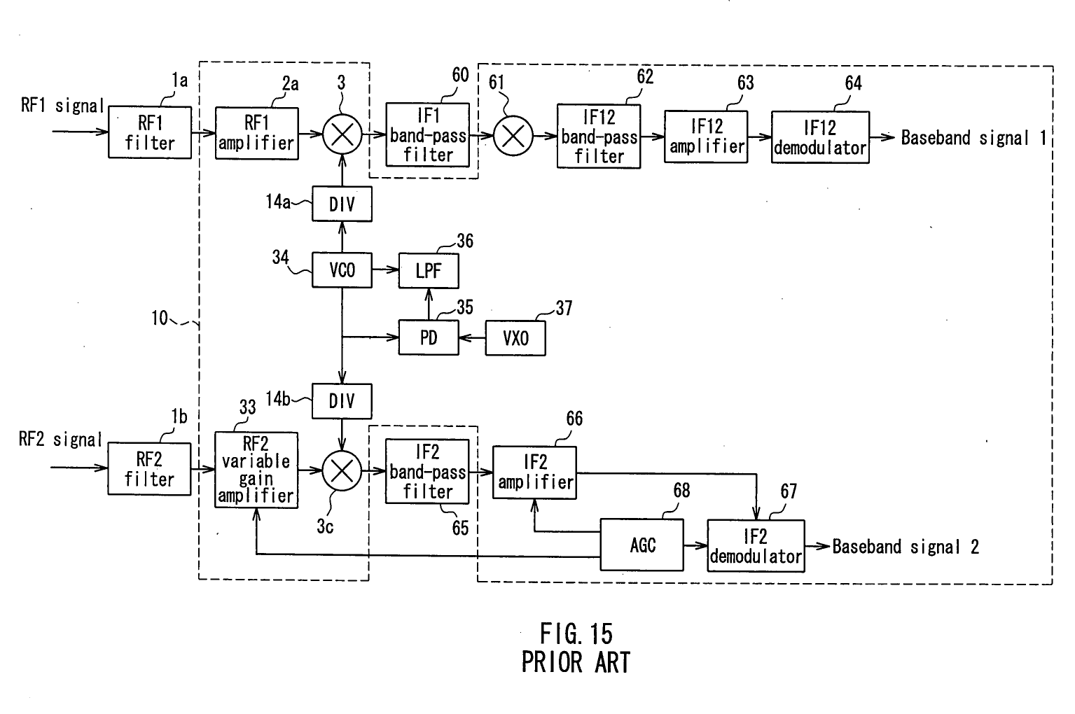

### DETAILED DESCRIPTION OF THE INVENTION

The receiver IF circuit of the present invention uses a polyphase filter for image rejection and a frequency variable band-pass filter composed of a switched capacitor filter (SCF) or the like, and thus allows the polyphase filter to function as an anti-aliasing filter for the frequency variable band-pass filter. Therefore, the receiver IF circuit can achieve high-performance integration at low cost.

It is preferable that the receiver IF circuit further includes a reference signal generator for generating a reference signal, and the local signal and the control signal are generated based on the reference signal. Accordingly, the frequency variable band-pass filter and the frequency converter can be synchronized to operate with high precision.

The receiver IF circuit further may include the following: a plurality of the frequency converters corresponding to a plurality of RF input signals for generating a plurality of signal groups of the polyphase intermediate-frequency signals; and a plurality of switches for switching the signal groups to be supplied to the polyphase filter, whereby the plurality of RF input signals in different frequency bands are received.

In this configuration, the receiver IF circuit further may include the following: a phase-locked loop for controlling a frequency of a voltage-controlled oscillator by using a signal of a quartz oscillator as a reference signal; a plurality of dividers for dividing an output signal of the voltage-controlled oscillator and supplying the resultant signals as the local signals to each of the frequency converters corresponding to the RF input signals; and a variable divider for dividing the signal of the quartz oscillator and supplying the resultant signal as the control signal to the frequency variable band-pass filter. By using an accurate clock, different characteristics can be achieved precisely with a single basic filter, so that the necessary chip area can be reduced.

The receiver IF circuit further may include the following: the frequency converter corresponding to some of a plurality of RF input signals for generating the polyphase intermediate-frequency signals; a frequency converter corresponding to the other of the RF input signals for generating a single-phase intermediate-frequency signal; and a plurality of switches for switching the polyphase intermediate-frequency signals and the single-phase intermediate-frequency signal to be supplied to the polyphase filter, whereby the plurality of RF input signals in different frequency bands are received.

In this configuration, the receiver IF circuit further may include the following: a phase-locked loop for controlling a frequency of a voltage-controlled oscillator by using a signal of a quartz oscillator as a reference signal; a plurality of dividers for dividing an output signal of the voltage-controlled oscillator and supplying the resultant signals as the local signals to each of the frequency converters corresponding to the RF input signals; and a variable divider for dividing the signal of the quartz oscillator and supplying the resultant signal as the control signal to the frequency variable band-pass filter.

The polyphase filter may be composed of a combination of passive polyphase filters or active polyphase filters.

The frequency variable band-pass filter may be composed of a switched capacitor filter. In this case, it is preferable that the polyphase filter also functions as an anti-aliasing filter for the switched capacitor filter composing the frequency variable band-pass filter.

It is preferable that a clock frequency of the control signal supplied to the switched capacitor filter composing the frequency variable band-pass filter is higher than an RF input signal band.

The receiver IF circuit further may include a plurality of variable gain amplifiers.

Hereinafter, the present invention will be described by way of illustrative embodiments with reference to the drawings.

### Embodiment 1

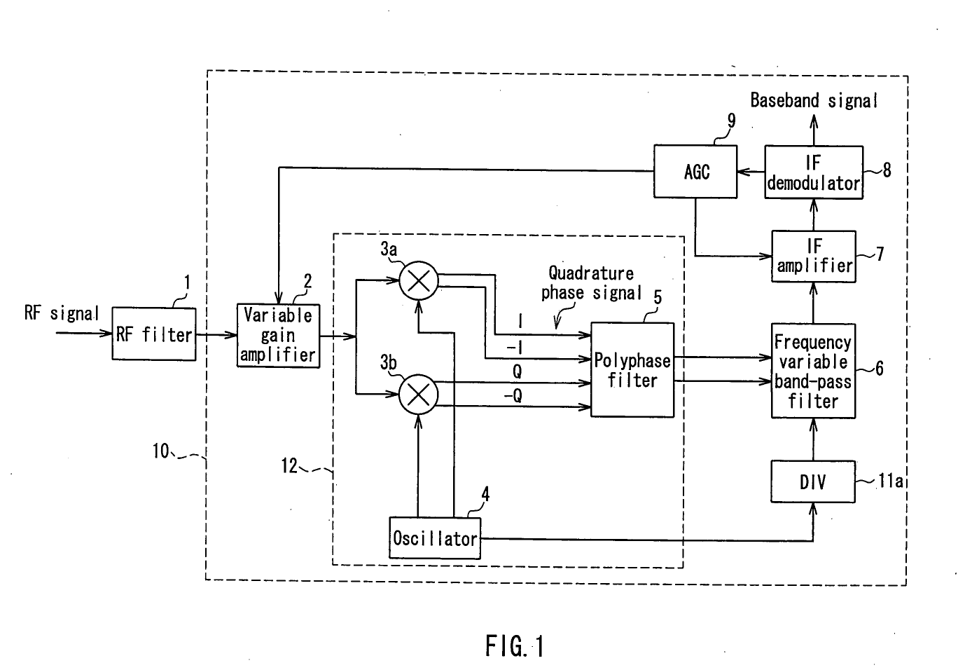

FIG. 1 shows a receiver IF circuit of Embodiment 1 of the present invention. An RF filter 1 selects the frequency of an RF input signal, and then a variable gain amplifier 2 amplifies the RF signal. The output signal of the variable gain amplifier 2 is supplied to a mixer 3a and a mixer 3b, in each of which the signal is mixed with an orthogonal local signal generated by an oscillator 4. Consequently, the RF signal is converted into polyphase intermediate-frequency signals, i.e., quadrature phase signals of I, −I, Q and −Q for suppressing the image component. The I, −I, Q and −Q signals are supplied to a polyphase filter 5. An image rejection mixer is formed by a block 12 enclosed with a broken like that includes the mixers 3a and 3b, the oscillator 4, and the polyphase filter 5.

The output of the polyphase filter 5 is supplied to a frequency variable band-pass filter 6 to select only a desired IF signal. The frequency variable band-pass filter 6 is controlled based on a control signal obtained by dividing the output signal of the oscillator 4 with a frequency divider 11a, and thus the selecting frequency is adjusted. The output of the frequency variable band-pass filter 6 is amplified by an IF amplifier 7 and subsequently is converted into a baseband signal by an IF demodulator 8. The output of the IF demodulator 8 is applied to an AGC 9, and a control voltage is supplied from the AGC 9 to the variable gain amplifier 2 and the IF amplifier 7, so that their gains are controlled to maintain the signal level constant based on the control voltage.

In this circuit, the frequency of the control signal supplied to the frequency variable band-pass filter 6 is varied by changing a dividing ratio of the frequency divider 11a, and thus the frequency selection characteristics can be changed.

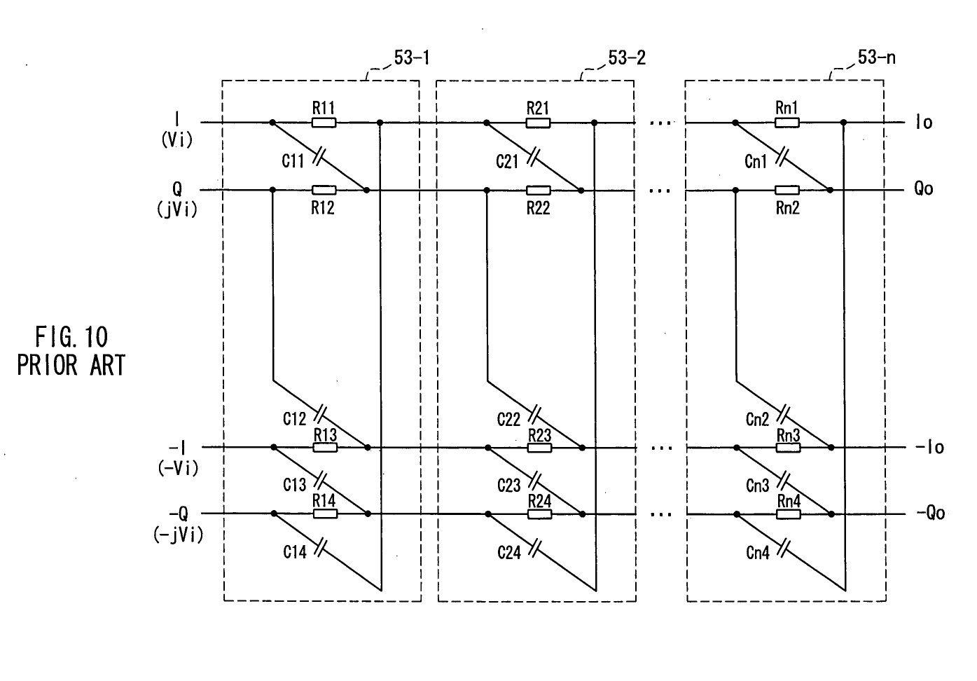

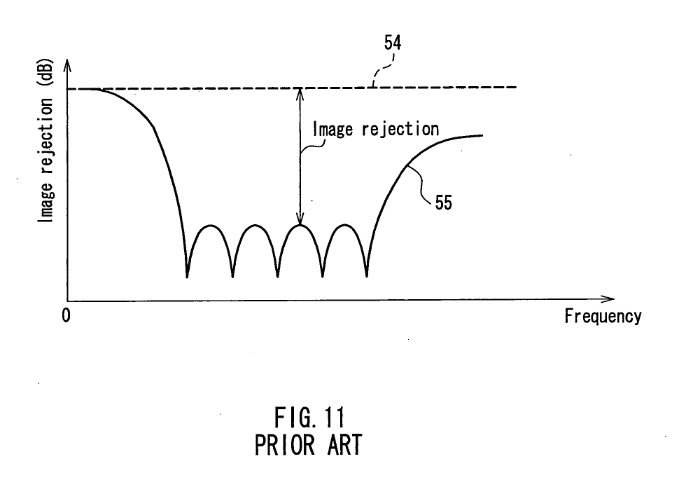

As an example of the polyphase filter 5, the passive polyphase filter in FIG. 10 may be used. The quadrature phase signals I, −I, Q and −Q that are output from the mixers 3a and 3b enter the passive polyphase filter with the same amplitude. The polyphase filters 53-1, 53-2, . . . and 53-n have a center frequency of f01=1/(2πR11×C11), f02=1/(2πR21×C21), and f0n=1/(2πRn1×Cn1), respectively. FIG. 11 shows the frequency characteristics of the passive polyphase filter as a whole. The passive polyphase filter exhibits the notch characteristics of the solid line 55 for an image signal and the substantially all-pass characteristics of the broken line 54 for a desired signal. The polyphase filters are connected in multiple stages. Therefore, even if the capacitors or resistors vary, the desired image rejection characteristics can be achieved.

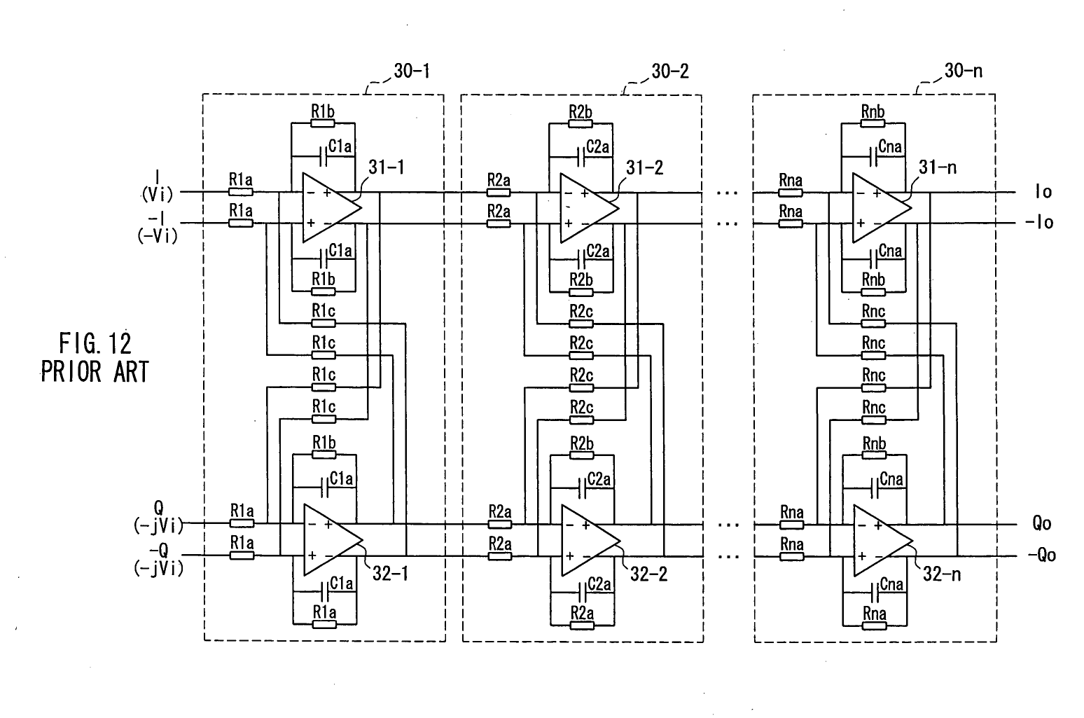

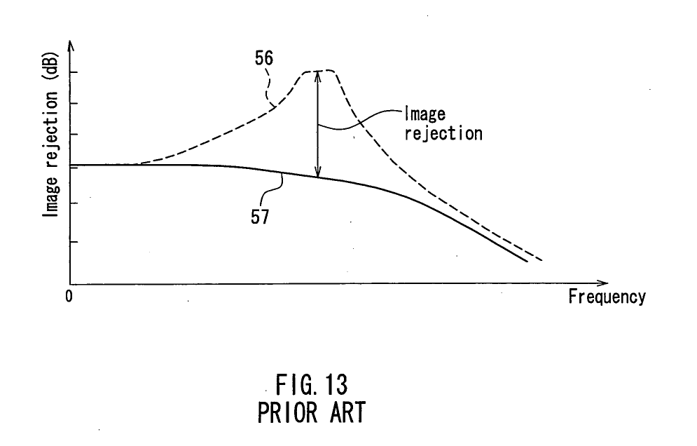

As another example of the polyphase filter 5, the active polyphase filter in FIG. 12 may be used. The quadrature phase signals I, −I, Q and −Q enter the active polyphase filter with the same amplitude. The BPFs 30-1, 30-2, . . . and 30-n have a center frequency of f01=1/(2πC1a×R1c), f02=1/(2πC2a×R2c), and f0n=1/(2πCna×Rnc) and a−3 dB bandwidth of BW1=2/(2πC1a×R1b), BW2=2/(2πC2a×R2b), and BWn=2/(2πCna×Rnc), respectively. FIG. 13 shows the frequency characteristics of the active polyphase filter. The active polyphase filter exhibits the BPF characteristics of the broken line 56 for a desired signal and those of the solid line 57 for an image signal. Therefore, the image rejection characteristics can be achieved.

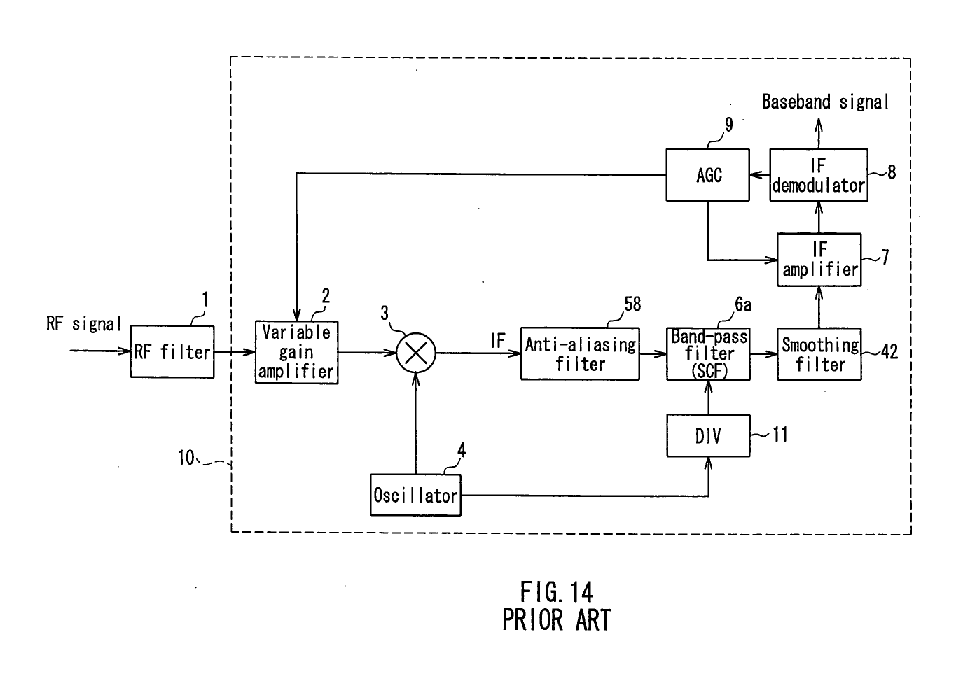

In the circuit of FIG. 1, the signal after passing through the polyphase filter 5 is supplied to the frequency variable band-pass filter 6, thereby providing the following effects. When the frequency variable band-pass filter 6 is composed of a switched capacitor filter (SCF), the anti-aliasing filter 58 generally has to be provided in the preceding stage of the SCF, as shown in the conventional example of FIG. 14. In contrast, the active polyphase filter in FIG. 12 can serve as an anti-aliasing filter because it has the image rejection function and acts at the same time as an active BPF, as shown in FIG. 13. This allows the polyphase filter 5 also to be used as an anti-aliasing filter, and thus can reduce the chip area and the electric power.

In order to achieve necessary attenuation at fs/2, where fs is the sampling frequency of the SCF, the polyphase BPFs can be connected in multiple stages to obtain the necessary attenuation. Moreover, the SCF has another great advantage of changing the frequency characteristics by varying the clock frequency.

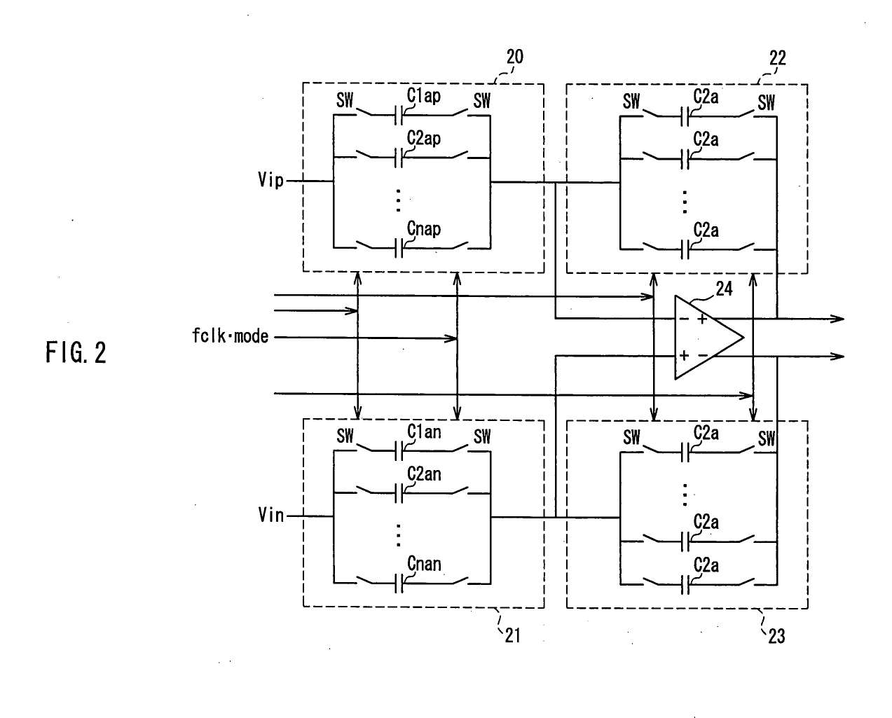

FIG. 2 shows an example of the SCF that can be used as the frequency variable band-pass filter 6. This SCF includes capacitor selection networks 20 to 23 and an operational amplifier 24. The capacitor selection network 20 includes capacitors C1ap to Cnap and switches SW. The capacitor selection network 21 includes capacitors C1an to Cnan and switches SW. The capacitor selection network 22 includes capacitors C2a and switches SW. The capacitor selection network 23 includes capacitors C2a and switches SW. The capacitance is selected by the selection mode of a necessary frequency, and a clock selected with respect to the necessary frequency is supplied to the switch SW. The SCF in FIG. 2 can constitute an integrator or a first-order basic filter. Thus, it is possible to form a filter with desired selecting characteristics by selecting the capacitor network and the clock frequency. The SCF also can constitute a second- or higher-order filter. All the filters can share the operational amplifier 24, thereby reducing the electric power and the cost.

### Embodiment 2

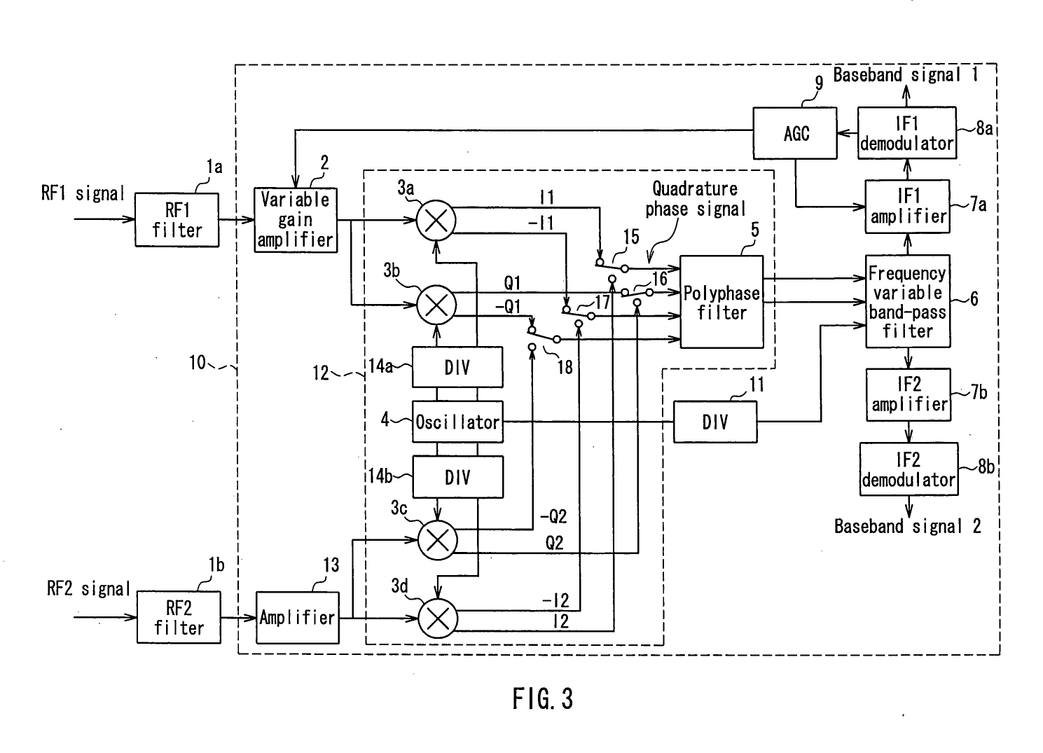

FIG. 3 shows a receiver IF circuit of Embodiment 2 of the present invention. Two RF input signals, i.e., RF1 and RF2 in different frequency bands are input to this circuit. After the frequency is selected by an RF filter 1a, the RF1 signal enters a variable gain amplifier 2. The signal amplified by the variable gain amplifier 2 is supplied to a mixer 3a and a mixer 3b. Similarly, after the frequency is selected by an RF2 filter 1b, the RF2 signal enters an amplifier 13. The signal amplified by the amplifier 13 is supplied to a mixer 3c and a mixer 3d.

Local signals obtained by dividing the output signal of an oscillator 4 with frequency dividers 14a and 14b are supplied to the mixers 3a, 3b, 3c and 3d to obtain a predetermined IF frequency. For image rejection, the local signals supplied to the mixers 3a and 3b differ in phase by 90 degrees. The local signals supplied to the mixers 3c and 3d also differ in phase by 90 degrees. Consequently, the mixers 3a and 3b output quadrature phase signals I1, −I1, Q1 and −Q1 having a frequency IF1, and the mixers 3c and 3d output quadrature phase signals I2, −I2, Q2 and −Q2 having a frequency IF2.

These signals with two different frequencies are switched by switches 15 to 18 and then supplied to a polyphase filter 5. The image rejection operation on the two RF input signals is performed by a block 12 that includes the mixers 3a to 3d, the oscillator 4, the frequency dividers 14a and 14b, the switches 15 to 18, and the polyphase filter 5.

The signal that has passed through the polyphase filter 5 is supplied to a frequency variable band-pass filter 6. The frequency variable band-pass filter 6 operates based on a control signal supplied from a frequency divider 11 whose dividing ratio can be changed. Accordingly, the frequency variable band-pass filter 6 can be used for each of the different intermediate frequencies IF1 and IF2.

In the configuration of FIG. 3, after the signal has passed through the frequency variable band-pass filter 6, the operations of the circuit for IF1 are the same as those in FIG. 1. The circuit for IF2 has no feedback loop. However, the circuit for IF2 may perform an AGC operation like the circuit for IF1, and the amplifier 13 may be a variable gain amplifier.

The receiver IF circuit of this embodiment allows the RF input signals with different frequencies to be processed by one polyphase filter 5 and one frequency variable band-pass filter 6. Therefore, it is possible to suppress an increase in chip cost and to reduce the electric power. Although two different RF input signals are input in FIG. 3, the similar configuration also can be used for three or more RF input signals based on the following characteristics.

(a) The control signal supplied to the frequency variable band-pass filter 6 can be selected optimally by the value of the frequency divider 11.

(b) The signal synchronized with each of the local frequencies that are supplied to the mixers 3a to 3d is supplied to the frequency variable band-pass filter 6.

(c) The polyphase filter 5 can perform the image rejection of the individual RF input signals and remove an undesired signal.

### Embodiment 3

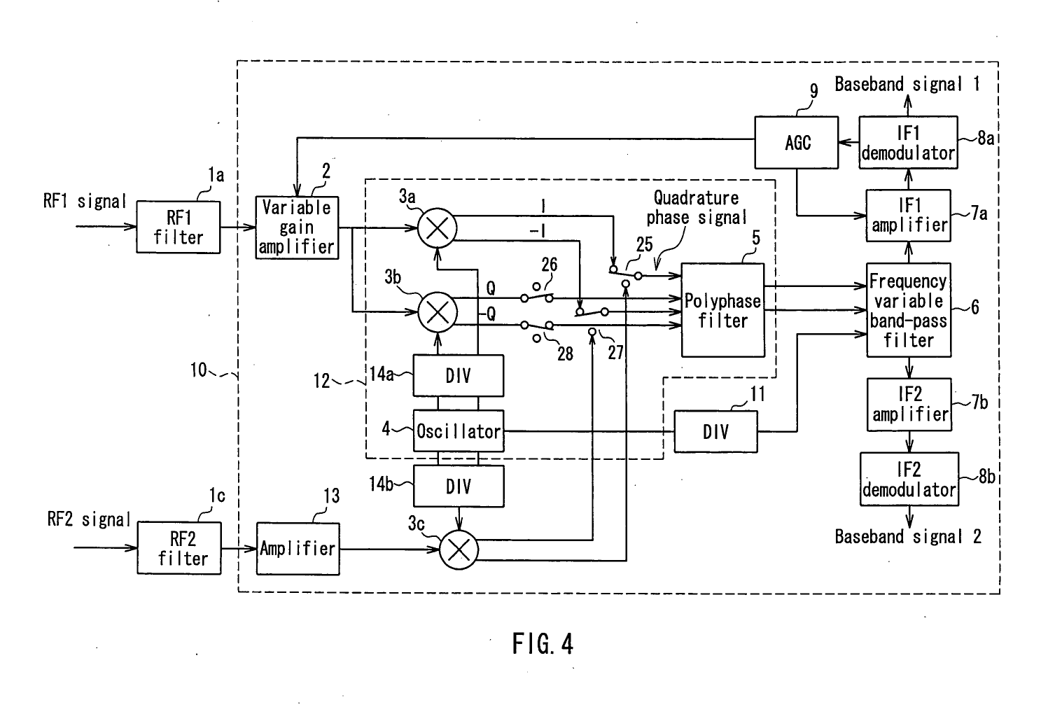

FIG. 4 shows a receiver IF circuit of Embodiment 3 of the present invention. Like the circuit in FIG. 3, two RF input signals, i.e., RF1 and RF2 in different frequency bands are input to this circuit. The circuit in FIG. 4 differs from the circuit in FIG. 3 in that an RF2 filter 1c (external filter) performs the image rejection of the RF2 signal.

For the RF1 signal, an image rejection mixer is formed by a block 12 that includes mixers 3a and 3b, an oscillator 4, a frequency divider 14a, switches 25 to 28, and a polyphase filter 5. For the RF2 signal, the polyphase filter 5 serves as part of a selection filter of a frequency variable band-pass filter 6. When the frequency variable band-pass filter 6 is composed of a SCF, the polyphase filter 5 serves as an anti-aliasing filter.

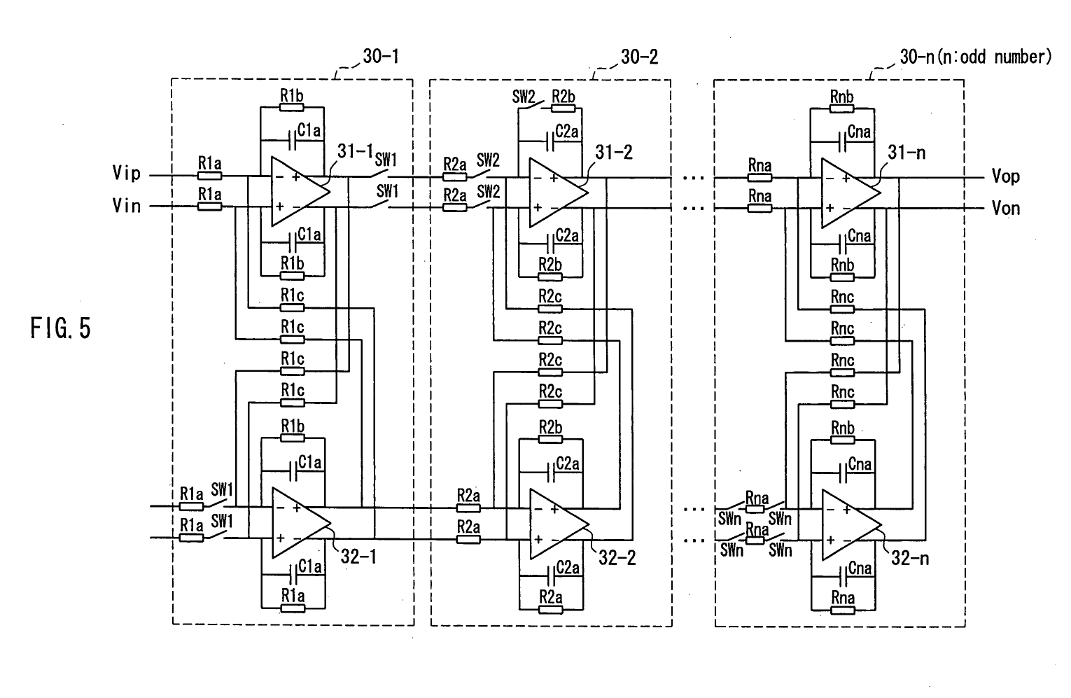

Other operations are the same as those of the circuit in FIG. 3. FIG. 5 shows an example of a circuit shared between an active polyphase BPF and an active biquadratic LPF. The shared circuit is formed by adding switches SW1, SW2, . . . and SWn to the active polyphase filter in FIG. 12. When the switches SW1, SW2, . . . and SWn are on, the circuit functions as the polyphase BPF. When the switches SW1, SW2, . . . and SWn are off, the circuit functions as the general biquadratic (bi-quad) LPF. Like the polyphase BPFs, the bi-quad LPFs can be connected in multiple stages to obtain the attenuation required for preventing aliasing.

### Embodiment 4

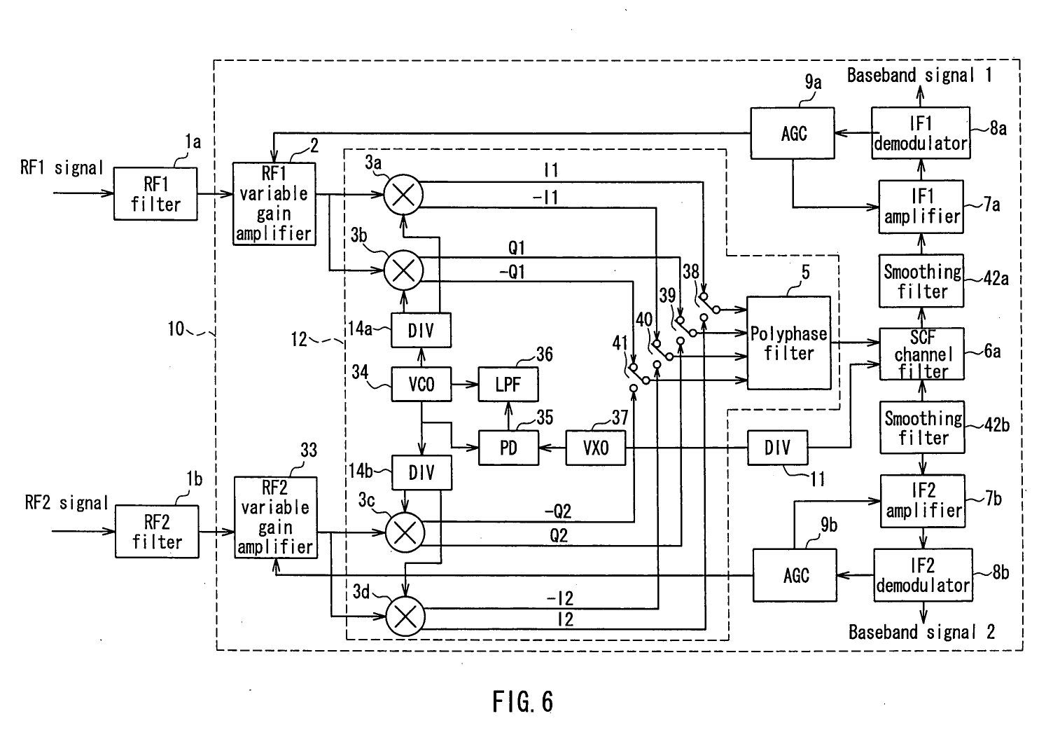

FIG. 6 shows a receiver IF circuit of Embodiment 4 of the present invention. Like the circuit in FIG. 3, two RF input signals, i.e., RF1 and RF2 in different frequency bands are input to this circuit. The RF1 signal enters an RF1 variable gain amplifier 2 through an RF1 filter 1a. The RF2 signal enters an RF2 variable gain amplifier 33 through an RF2 filter 1b. After amplification of the signals, a first orthogonal mixer including mixers 3a, 3b and a second orthogonal mixer including mixers 3c, 3d generate quadrature phase signals having two different frequencies IF1 and IF2, respectively.

Local signals are supplied from a frequency divider 14a to the mixers 3a and 3b. Similarly, local signals are supplied from a frequency divider 14b to the mixers 3c and 3d. The output signal of a phase-locked loop using the output signal of a quartz oscillator 37 as a reference signal is supplied to the frequency dividers 14a, 14b and converted into necessary local frequencies. The phase-locked loop includes a voltage-controlled oscillator 34, a phase comparator 35, a LPF 36, and the quartz oscillator 37.

The quadrature phase signals having frequencies IF1, IF2 are switched by switches 38 to 41 and supplied to a polyphase filter 5. The output of the polyphase filter 5 is supplied to a SCF channel filter 6a composed of a SCF. A control signal having a predetermined frequency is obtained by dividing the reference signal of the quartz oscillator 37 with a divider 11, and then is supplied to the SCF channel filter 6a. The divider 11 can switch the frequency of the control signal in accordance with the frequency to be selected by switching of the switches 38 to 41.

In this circuit, when the polyphase filter 5 has the configuration as shown in FIG. 10 or 12, it also can be used as an anti-aliasing filter for the SCF channel filter 6a. That is, the polyphase filter 5 sufficiently attenuates the input signal of the SCF channel filter 6a to half the frequency of a clock of the SCF channel filter 6a. Consequently, aliasing can be prevented, and the signals that have passed through the smoothing filters 42a and 42b become selected IF signals without any distortion.

The signal through the smoothing filter 42a is processed by an IF1 amplifier 7a and an IF1 demodulator 8a, so that a baseband signal 1 is output. Similarly, the signal through the smoothing filter 42b is processed by an IF2 amplifier 7b and an IF2 demodulator 8b, so that a baseband signal 2 is output. The outputs of the IF1 demodulator 8a and the IF2 demodulator 8b are supplied to AGCs 9a and 9b, respectively. Thus, the gains of the variable gain amplifiers 2 and 33, the IF1 amplifier 7a, and the IF2 amplifier 7b are controlled.

In this embodiment, the image rejection function required for two different RF signals can be achieved by a common image rejection mixer (i.e., a block 12 enclosed with a broken line). Moreover, the selection filter of two different frequencies can be integrated as a common SCF channel filter 6a in the same chip. Thus, the number of external filters can be decreased to reduce cost and electric power.

The switched capacitor filter is a discrete-time system and includes many harmonic contents of the clock frequency. Therefore, when the switched capacitor filter is integrated with a small RF circuit in the same chip, the harmonic contents may affect the RF circuit as noise, and also may be undesired components for the mixers. If the clock frequency is higher than the frequency of the RF input signal, the harmonic contents are attenuated during transmission over the circuit. At the same time, the effect of the harmonic contents as noise on the input signal band can be reduced. Accordingly, the clock frequency of the SCF is made higher than the frequency of the RF input signal to prevent the components of the signal processed by the SCF from being a disturbing wave of the RF circuit.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. An receiver IF circuit comprising:
a variable gain amplifier for amplifying an RF input signal;
a frequency converter for mixing the amplified RF input signal and a local signal to generate polyphase intermediate-frequency signals that are used for suppressing an image component;
a polyphase filter for receiving the polyphase intermediate-frequency signals and outputting an intermediate-frequency signal whose image component is suppressed;
a frequency variable band-pass filter for selecting a channel of the intermediate-frequency signal while changing a frequency response in accordance with a supplied control signal;
an IF demodulator for demodulating the intermediate-frequency signal; and
an automatic gain control for detecting a level of an output signal of the IF demodulator and controlling a gain of the variable gain amplifier in accordance with the detected level.

2. The receiver IF circuit according to claim 1, further comprising a reference signal generator for generating a reference signal,
wherein the local signal and the control signal are generated based on the reference signal.

3. The receiver IF circuit according to claim 1, further comprising:
a plurality of the frequency converters corresponding to a plurality of RF input signals for generating a plurality of signal groups of the polyphase intermediate-frequency signals; and
a plurality of switches for switching the signal groups to be supplied to the polyphase filter,
whereby the plurality of RF input signals in different frequency bands are received.

4. The receiver IF circuit according to claim 3, further comprising:
a phase-locked loop for controlling a frequency of a voltage-controlled oscillator by using a signal of a quartz oscillator as a reference signal;
a plurality of dividers for dividing an output signal of the voltage-controlled oscillator and supplying the resultant signals as the local signals to each of the frequency converters corresponding to the RF input signals; and
a variable divider for dividing the signal of the quartz oscillator and supplying the resultant signal as the control signal to the frequency variable band-pass filter.

5. The receiver IF circuit according to claim 1, further comprising:
the frequency converter corresponding to some of a plurality of RF input signals for generating the polyphase intermediate-frequency signals;
a frequency converter corresponding to the other of the RF input signals for generating a single-phase intermediate-frequency signal; and
a plurality of switches for switching the polyphase intermediate-frequency signals and the single-phase intermediate-frequency signal to be supplied to the polyphase filter,
whereby the plurality of RF input signals in different frequency bands are received.

6. The receiver IF circuit according to claim 5, further comprising:
a phase-locked loop for controlling a frequency of a voltage-controlled oscillator by using a signal of a quartz oscillator as a reference signal;
a plurality of dividers for dividing an output signal of the voltage-controlled oscillator and supplying the resultant signals as the local signals to each of the frequency converters corresponding to the RF input signals; and
a variable divider for dividing the signal of the quartz oscillator and supplying the resultant signal as the control signal to the frequency variable band-pass filter.

7. The receiver IF circuit according to claim 1, wherein the polyphase filter is composed of a combination of passive polyphase filters or active polyphase filters.

8. The receiver IF circuit according to claim 1, wherein the frequency variable band-pass filter is composed of a switched capacitor filter.

9. The receiver IF circuit according to claim 8, wherein the polyphase filter also functions as an anti-aliasing filter for the switched capacitor filter composing the frequency variable band-pass filter.

10. The receiver IF circuit according to claim 8, wherein a clock frequency of the control signal supplied to the switched capacitor filter composing the frequency variable band-pass filter is higher than an RF input signal band.

11. The receiver IF circuit according to claim 1, further comprising a plurality of variable gain amplifiers.
